(19) United States
(12) Patent Application Publication
(10) Pub. No.: US 2026/0336445 A1
(43) Pub. Date: Oct. 29, 2026

(54) POSITIONING UNIT, IN PARTICULAR FOR A CHARGING STATION, AND METHOD FOR CONTACTING

(71) Applicant: SCHUNK TRANSIT SYSTEMS GMBH, Wettenberg (DE)

(72) Inventors: Timo Staubach, Herbstein (DE); Nils Heieis, Lich (DE); Holger Leib, Heuchelheim (DE); Martin Feldinger, Seekirchen am Wallersee (AT); Johann Uebertsberger, Buermoos (AT); Matthias Domes, Bad Nauheim (DE)

(21) Appl. No.: 19/104,915

(22) PCT Filed: Aug. 19, 2022
(86) PCT No.: PCT/EP2022/073213

§ 371 Date: Feb. 19, 2025

(51) Int. Cl. B60L 53/35; B60L 53/16; B60L 53/18; B60L 53/31; B60L 53/62

(52) U.S. Cl. CPC B60L 53/35; B60L 53/16; B60L 53/18; B60L 53/31; B60L 53/62; B60L 2200/18

(57) ABSTRACT

The invention relates to a positioning unit (10) for producing electrically conductive connection between a stationary charging station and an electrically powered vehicle, in particular an electric bus or the like, an electric charging contact (11) of a contact device (12) of the positioning unit being movable in relation to a charging contact surface and being contactable therewith by means of the positioning unit, the positioning unit having an articulated arm device (13) and a power device (14) for powering the articulated arm device, the charging contact being positionable between a contact position for current transmission and a retracted position for current interruption by means of the articulated arm device, the positioning unit having at least one electric conductor (17a, 17b) provided for transmitting a charging current and essentially disposed on the articulated arm device, which is connected to the charging contact at one end and is connectable to the charging station or to the vehicle at the other end, the conductor having at least one section (19a, 19b) formed predominantly, preferably completely, of aluminum.

The invention relates to a positioning unit and a method for producing an electrically conductive connection between a stationary charging station and an electrically powered vehicle, in particular an electric bus or the like, an electric charging contact of a contact device of the positioning unit being movable in relation to a charging contact surface by means of the positioning unit and being contactable therewith, the positioning unit having an articulated arm device and a power device for powering the articulated arm device, the charging contact being positionable between a contact position for current transmission and a retracted position for current interruption by means of the articulated arm device, the positioning unit having at least one electric conductor provided for transmitting a charging current and essentially disposed on the articulated arm device, the electric conductor being connected to the charging contact at one end and being connectable to the charging station or to the vehicle at the other end,

Such positioning units and methods are known from the prior art and are regularly used in electrically powered vehicles. These vehicles can be electric buses, but in principle can also be other vehicles, such as a train, a streetcar or a ferry, which are not permanently electrically connected to an overhead wire or similar. In these vehicles, an electric energy storage device is charged by a charging station during a break at a stop or at a vehicle depot. The vehicle is electrically connected to the charging station in the depot, the vehicle's energy storage unit being charged overnight, for example.

A contact device, which is mounted or positioned on the positioning unit above the vehicle at a parking space of the vehicle in the depot or at a bus stop, is used to produce an electrically conductive connection between the vehicle and the charging station. A charging contact of the contact device is then moved in the direction of a charging contact surface on a roof of the vehicle by means of the positioning unit and an electric connection is produced. For example, a contact device can have at least four charging contacts, it then being possible for two charging contacts to be used regularly for energy transmission, it being possible for one charging contact to serve as a grounding conductor and another charging contact to serve to transmit data. Grounding can be realized and carried out via a pantograph frame of the positioning unit. A generic positioning unit is known from DE 2015 217 380 A1, for example.

The charging contact is moved into a contact position for current transmission by means of an articulated arm device of the positioning unit for the purpose of charging the energy storage device and, in this position, a charging current is transmitted regularly via an electric conductor of the positioning unit essentially disposed on the articulated arm device, electric conductor being connected to the charging contact at one end and to the charging station at the other end and being connected thereto in such a way that the charging current can pass from the charging station to the charging contact contacted with the charging contact surface via the conductor and, from there, to the energy storage device via the charging contact surface. In the positioning units known from the prior art, the conductor is always essentially formed completely of copper. It is true that only a charging current of 600 A can be transmitted regularly with the previously known positioning units or their conductors, which means that the charging time is limited downwards and is relatively long. An increase in the charging current is therefore desirable to reduce the charging time.

In principle, a current flow in a conductor generates heat, which can lead to damage, in particular to the conductor itself or at contact junctions. For this reason, care must always be taken to ensure that a current transmitted by a conductor is compatible with the ampacity or current-carrying capacity of the conductor. The ampacity is understood to be the maximum permissible current that a conductor can carry continuously under specified conditions without a permissible temperature of the conductor exceeding a specific value. The ampacity of a conductor depends on the material of the conductor and the geometry, in particular of a cross-sectional area, of the conductor, the ampacity basically increasing with increasing cross-sectional area.

Therefore, the conductor must have a comparatively higher ampacity in order for it to be able to transmit a comparatively higher charging current via the conductor of the positioning unit to achieve a comparatively shorter charging time. This can basically be achieved by selecting a conductor with a comparatively larger cross-sectional area. However, it should be noted that the weight of the conductor also increases as the cross-sectional area of the conductor increases. It should also be borne in mind that the conductor of the positioning unit is essentially disposed on the articulated arm device powered by a power device of the positioning unit, a power of the power device in particular also being matched to a specific weight of the components powered thereby, in particular that of the articulated arm device and of the conductor essentially disposed on the articulated arm device. The cross-sectional area of the conductor and, with that, the weight of the conductor in a previously known positioning unit with a copper conductor therefore cannot be readily increased in order to improve the charging time or ampacity of the conductor, as otherwise additional adjustments would have to be made to the power device, which would require costly measures. There is also the fact that an increase in the cross-sectional area of the conductor or copper conductor would require more comparatively expensive copper material.

The present invention is therefore based on the problem of proposing a positioning unit and a method for producing an electrically conductive connection between a stationary charging station and an electrically powered vehicle, by means of which a charging time can be reduced with simple means and at low cost by increasing a charging current.

This problem is solved by a positioning unit with the features of claim 1 and a method with the features of claim 21.

In the positioning unit according to the invention for producing an electrically conductive connection between a stationary charging station and an electrically powered vehicle, in particular an electric bus or the like, an electric charging contact of a contact device of the positioning unit is movable in relation to a charging contact surface and is contactable therewith by means of the positioning unit, the positioning unit having an articulated arm device and a power device for powering the articulated arm device, the charging contact being positionable between a contact position for current transmission and a retracted position for current interruption by means of the articulated arm device, the positioning unit having at least one electric conductor provided for transmitting a charging current and essentially disposed on the articulated arm device, the electric conductor being connected to the charging contact at one end and being connectable to the charging station or to the vehicle at the other end, the conductor having at least one section formed predominantly, preferably completely, of aluminum.

The positioning unit can therefore be a component of a stationary charging station for an electrically powered vehicle and can serve to move the electric charging contact or the charging contacts onto a charging contact surface of the vehicle, which can be disposed on a vehicle roof, and to electrically contact same in each case. The movement of the charging contact or charging contacts onto the respective charging contact surface is carried out through the positioning unit, which can be disposed above the vehicle on a roof structure. The charging contact or the charging contacts can be disposed on a lower end of the positioning unit and moved from an upper retracted position to a lower contact position for current transmission or contacting of the charging contact surfaces. This movement of the charging contact or charging contacts takes place through the articulated arm device, which can be actuated or powered by the power device. Alternatively, the positioning unit can also be a component of the vehicle and be disposed on the vehicle roof, it being possible for the charging contact surface to be disposed on a roof structure above the vehicle. In this case, the charging contact or the charging contacts can then be moved from a lower retracted position to an upper contact position for current transmission or contacting of the charging contact surfaces.

Further, the positioning unit has at least one electric conductor provided for transmitting a charging current, the electric conductor being essentially disposed on the articulated arm device. One end of the conductor is connected to the charging contact and the other end of the conductor can be routed to the charging station or to the vehicle or is connectable to either or both. In the contact position, a charging current can then flow through the conductor from the charging station to the vehicle.

According to the invention, it is provided that the conductor has at least one section formed predominantly, preferably completely, of aluminum, i.e. is formed predominantly, preferably completely, of aluminum, at least in sections, with respect to a material of the section. As the weight or density of aluminum is considerably lower, in particular when compared to copper, it is therefore possible to form the section with a comparatively larger cross-sectional area at the same weight, so that a comparatively larger charging current can be transmitted by means of the conductor at the same weight, thereby advantageously reducing charging time. The cross-sectional area of the section can be selected to be just large enough so that the weight of the conductor, at least, does not exceed the weight of a conductor or copper conductor formed completely of copper used in a previously known positioning unit. The section and at least one other conductor section, formed of copper, for example, which the conductor can have, can be matched to each other in such a way that the comparatively larger charging current can be transmitted with essentially the same weight of the conductor. Thus, according to the invention, the reduction in charging time can be achieved simply by adapting the conductor, without the need for costly adaptation of the power device. Advantageously, the section is formed completely of aluminum. The conductor can also only be formed almost completely of aluminum. It is conceivable to form the section from an aluminum alloy in which an aluminum content can predominate, preferably significantly. For example, the aluminum content in the aluminum alloy can then be more than 50% or at least 55%, 60%, 65%, 70%, 75%, 80%, 85%, 90%, 91%, 92%, 93%, 94%, 95%, 96%, 97%, 98% or 99%. Further, the conductor can have several such sections, in particular two such sections. These sections can then be connected to each other in an electrically conductive manner. The sections can be formed in the same way or differently rom each other, in particular as different profiles. Further, it should be pointed out that aluminum is comparatively cheaper than copper, so that the reduction in charging time can be achieved at comparatively lower cost against this background as well. As a result, the charging time can be reduced by means of the positioning unit according to the invention, this reduction being able to be achieved with simple and cost-effective measures.

Advantageously, the conductor can be formed predominantly of aluminum based on the length of the conductor. A length of the conductor section or a total length of multiple such conductor sections can then account for more than 50% or at least 55%, 60%, 65%, 70%, 75%, 80%, 85%, 90% or 95% of the length of the conductor. It is also conceivable that the conductor is formed completely of aluminum with respect to the length of the conductor.

Advantageously, the cross-sectional area of the section can be 300 mm² to 500 mm², preferably 400 mm². This allows the transmission of comparatively large charging currents. However, it is also conceivable to select a larger or considerably larger cross-sectional area.

Advantageously, the section can be formed as a profile part, preferably as a rail. The section can also be designed as a bar or an edge profile.

Advantageously, the conductor can have insulation, preferably in the form of a powder coating, in one area of the section. Powder coating can be used to apply a uniform layer to the aluminum material insulating the section from the outside. In particular, an insulating material can comprise a plastic.

Further, the conductor can have at least one other section formed predominantly, preferably completely, of copper. The conductor can also have insulation in one area of the other section. In particular, the other section together with the insulation can then form a cable. The other section can be electrically connected to the section. Advantageously, the other section is formed completely of copper. However, it is also conceivable to form the other section of a copper alloy in which a copper content can predominate. A length of the other conductor section or a total length of multiple such other conductor sections can then advantageously account for less than 50% or at most 45%, 40%, 35%, 30%, 25%, 20%, 15%, 10% or 5% of the length of the conductor, in order to be able to form the section with the largest possible cross-sectional area with essentially the same weight of the conductor in order to achieve the reduction in charging time. A cross-sectional area of the other section can then be adapted and matched to the cross-sectional area of the section in such a way that the desired charging current can be transmitted by means of the conductor. The adjustment can take place in such a way that the weight of the conductor, at least, does not exceed the weight of a conductor formed completely of copper or copper conductor, while the ampacity is increased by comparison. The other section can then be advantageously provided at kinks or in a bent conductor section or in a conductor section exposed to bending stress. As copper can withstand bending stress better compared to aluminum, breaking or tearing of the conductor in this conductor section can be avoided. The other section can connect two sections to each other, but can also form an end conductor section. For example, the other section can then also be connected to a charging contact or can be connectable to the charging station or to the vehicle. Likewise, the section can be connected to a charging contact or can be connectable to the charging station or to the vehicle.

The section can be coated with nickel in order to reduce transitional resistance, at least at one contact point at which the section contacts the other section. The section can also be completely coated with nickel.

The at least one section and the at least one other section can together form the conductor.

In the present case, the term “section” always refers to a section of a conductor formed predominantly, preferably completely, of aluminum, while the term “other section” with the addition “other” always refers to a section of a conductor formed predominantly, preferably completely, of copper.

A cross-sectional area of the other section can be 100 mm² to 150 mm², preferably 120 mm². However, the cross-sectional area of the other section can also be the same size as the cross-sectional area of the section.

Further, the other section can be formed as a strand, preferably as a round strand.

Advantageously, a charging current of 800 A to 1500 A, preferably 1000 A to 1200 A, can be transmittable via the conductor. This can significantly reduce loading time. Depending on the design of a cross-sectional area of the conductor or the cross-sectional area of the section or the other section, the charging current can also be greater or significantly greater.

Advantageously, the positioning unit can have a plurality of such conductors. Advantageously, the conductors are then formed similarly. In particular, the positioning unit can have two such conductors, which can lead the charging current to one charging contact intended for energy transmission in each case or to different charging contacts.

Advantageously, the articulated arm device can be formed as a single-arm system or as a crossbar system, preferably with a parallelogram guide, or as a pantograph. The articulated arm device can thus enable parallel movement of the charging contact, starting from a retracted position of the charging contact to the contact position at the charging contact surface of the vehicle.

In an advantageous embodiment of the invention, the articulated arm device can have at least a first arm member and a second arm member connected to the first arm member in an articulated manner, the conductor having two sections formed predominantly, preferably completely, of aluminum, a first section of the two sections being disposed on the first arm member and a second section of the two sections being disposed on the second arm member, the two sections being connected to each other in an electrically conductive manner in a joint area of the articulated arm device by means of the other conductor section, which is formed predominantly, preferably completely, of copper. The first arm member and the second arm member can be connected to each other in an articulated manner by means of at least one joint of the articulated arm device provided in the joint area. As the other section in the joint area is subjected to continuous kinking stress or bending stress due to retraction and extension of the articulated arm device, it can be ensured as a result that the conductor in this conductor section or in the joint area can withstand this continuous kink stress or bending stress. The other section can be relatively short compared to the two sections in order to optimize the ampacity of the conductor or the total weight of the positioning unit. In terms of the cross-sectional area, the condition of the other section can be such that it can transmit the same charging current as the adjacent two conductor sections. The second section can be connected to the charging contact on the end side, while the first section can be connectable to the charging station or to the vehicle on the end side. Advantageously, the positioning unit can have two such conductors, which can be connected to two different charging contacts to provide an electric positive pole and an electric negative pole. The contact device can be disposed on the end side of the second arm member. The articulated arm device can also comprise other articulated arm members at which sections, which can be connected to other sections in an electrically conductive manner, can be disposed In corresponding joint areas.

Advantageously, the conductor can have three other sections formed predominantly, preferably completely, of copper, it being possible for a first other section of the three other sections to connect the two sections to each other in the joint area in an electrically conductive manner, it being possible for a second other section of the three other sections to connect the second section to the charging contact in an electrically conductive manner or to be connected to the charging contact, it being possible for a third other section of the three other sections, which is connected to the first section in an electrically conductive manner, to be connectable to the charging station or to the vehicle. Therefore, the conductor can have five connected conductor sections, namely, two sections and three other sections. The second other section and the third other section can then form end conductor sections. As the conductor can also be subjected to continuous kink stress in an area of the contact device or in an area of a support frame of the positioning unit, which can be provided for fastening the positioning unit and on which the articulated arm device can be disposed, in particular over the first arm member, this construction of the conductor can prevent the conductor from tearing in conductor sections running through these areas. A connection or a connecting bar of the support frame can be provided on the support frame, to which the third other section can be connected, the charging station or to the vehicle being connectable to the connection. Advantageously, the other sections can be formed in the same way. Advantageously, the positioning unit can have two such conductors.

Advantageously, the first arm member can be formed as a single arm and the second arm member as a double arm, it being possible for the contact device to be disposed on the end side of the second arm member. However, the first arm member can also be formed as a double arm or the second arm member as a single arm.

Advantageously, the positioning unit can have two conductors, it being possible for a second conductor section, preferably formed completely of aluminum, to be disposed on each of two arms of the double arm running parallel to each other, at least in sections. Two first conductor sections formed predominantly, preferably completely, of aluminum can then be provided on the single arm, preferably spaced apart from each other, it being possible for each first section to be connected in an electrically conductive manner to one of the second sections provided on the double arm by means of another conductor sections formed predominantly, preferably completely, of copper. The two second sections can be connected to two different charging contacts on the end side, while the two first sections can be connectable to the charging station or to the vehicle. Advantageously, the two second sections can be connected to the charging contacts via a second other section in each case, while the two first sections can be connectable to the charging station or to the vehicle via a third other section in each case.

Advantageously, the power device can have an actuator for producing an actuation force acting on the articulated arm device and a spring device interacting mechanically with the actuator. The spring mechanism can be formed by one or more springs. The actuator can be a pneumatic, hydraulic or electromechanical drive that can act on the articulated arm device and move it into the contact position and, optionally, into the retracted position. The spring mechanism can be used to exert a defined contact force on the respective charging contact surfaces. Further, the spring mechanism can be formed such that the articulated arm device can be moved into the retracted position by a spring force if the actuator fails.

The contact device can have two charging contact carriers, with at least two charging contacts disposed thereon in each case. The positioning unit can then have a total of four charging contacts. Two of the charging contacts can be used for energy transmission, one charging contact as a grounding conductor and another charging contact for data transmission.

The charging contacts can be connected to each other via a rod assembly of the contact device with at least one connecting rod for connecting two charging contacts in each case and with at least one carrier rod for connecting the charging contact carriers to each other, the carrier rod being disposed transversely to the connecting rods. The rod assembly then makes it possible to distribute a contact force evenly to all charging contacts and to exert such force on the respective charging contact surfaces via the charging contacts. Movement of the vehicle during a charging process can also be compensated via the rod assembly.

Further, the positioning unit can have a support frame for fastening the positioning unit above the vehicle. Alternatively, the support frame can also be formed to fasten the positioning unit to a vehicle roof.

The charging station according to the invention comprises a mast, a boom or a bridge and a positioning unit according to the invention disposed thereon above a vehicle. Alternatively, an electrically powered vehicle can comprise the positioning unit according to the invention.

Other advantageous embodiments of the charging station result from the descriptions of features of the subclaims referring back to device claim 1.

In the method according to the invention for producing an electrically conductive connection between a stationary charging station and an electrically powered vehicle, in particular an electric bus or the like, an electric charging contact of a contact device of the positioning unit is moved in relation to a charging contact surface by means of a positioning unit and contacted therewith, an articulated arm device of the positioning unit powered by a power device of the positioning unit, the charging contact being positioned between a contact position for current transmission and a retracted position for current interruption by means of the articulated arm device, a charging contact being transmitted in the contact position via at least one electric conductor of the positioning unit essentially disposed on the articulated arm device, the electric conductor being connected to the charging contact at one end and connected to the charging station or to the vehicle at the other end, the charging current being transmitted via at least one conductor section formed predominantly, preferably completely, of aluminum. Reference is made to the description of the advantages of the positioning unit according to the invention with regard to the advantageous effects of the method according to the invention.

Other advantageous embodiments of the method result from the descriptions of features of the subclaims referring back to device claim 1.

A preferred embodiment of the invention is explained in more detail with reference to the appended drawings in the following.

### BRIEF DESCRIPTION OF THE DRAWINGS

FIG. 1 is a perspective side view of the positioning unit in a contact position;

FIG. 2 is a perspective side view of the positioning unit in a retracted position;

FIG. 3 is a partial perspective view of the positioning unit in the contact position from the front.

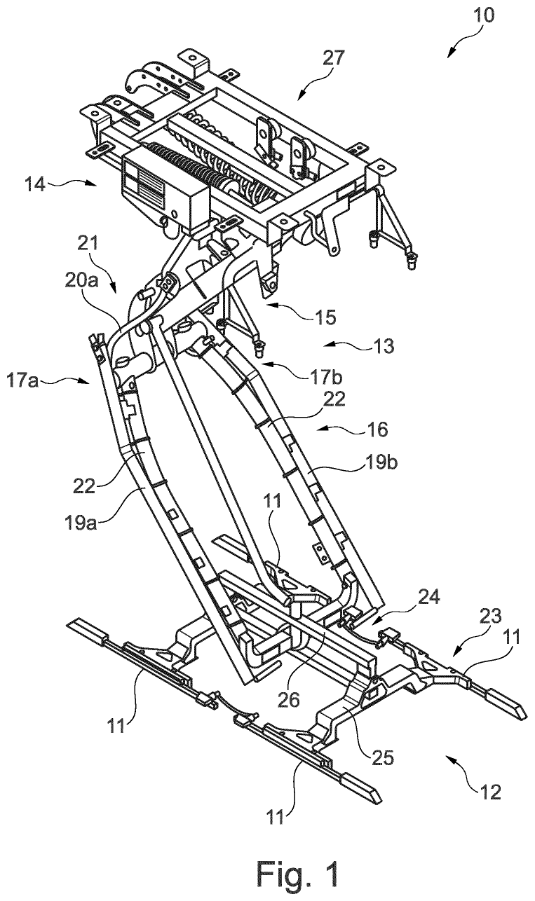

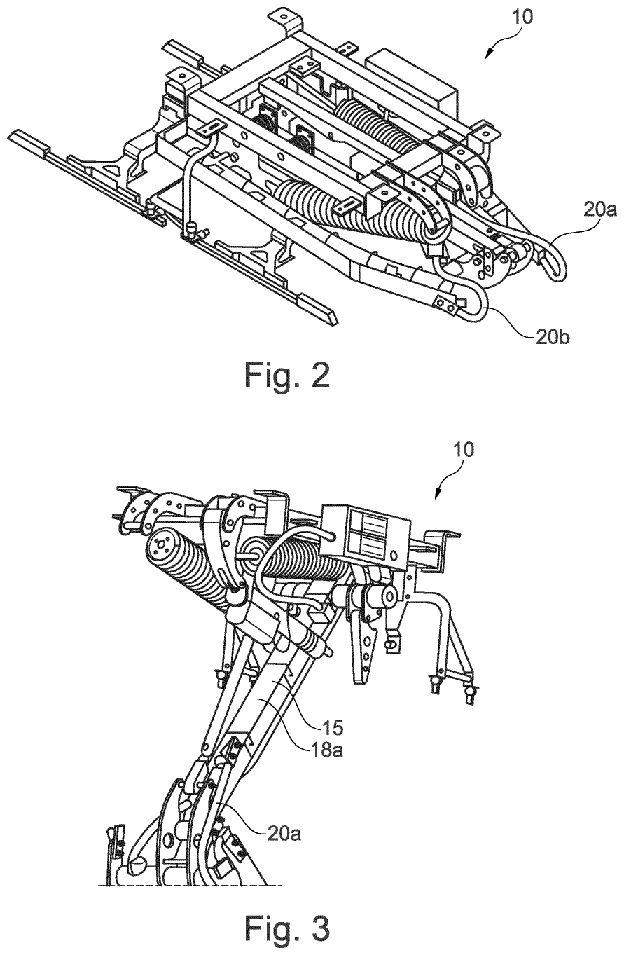

A synopsis of FIGS. 1 to 3 shows a positioning unit 10 for producing an electrically conductive connection between a stationary charging station not shown here and an electrically powered vehicle also not shown here, four electric charging contacts 11 of a contact device 12 of the positioning unit 10 being movable in relation to a charging contact surface not shown here and being contactable therewith by means of the positioning unit 10, the positioning unit 10 having an articulated arm device 13 and a power device 14 for powering the articulated arm device 13, the charging contacts 11 being positionable between a contact position for current transmission, which is shown in FIG. 1, and a retracted position for current interruption, which is shown in FIG. 2, by means of the articulated arm device 13.

In the present case, the articulated arm device 13 has a first arm member 15 and a second arm member 16 connected to the first arm member 15 in an articulated manner, the first arm member 15 being formed as a single arm and the second arm member 16 being formed as a double arm, the contact device 12 being disposed on the end side of the second arm member 16. Further, the positioning unit 10 has two electric conductors 17a, 17b provided for transmitting a charging current and essentially disposed on the articulated arm device 13, the electric conductors 17a, 17b each being connected to one of the charging contacts 11 at one end and being connectable, in particular, to the charging station at the other end. Each conductor 17a, 17b has a first section 18a, 18b, of which only the first section 18a can be seen in the figures due to the perspective, and a second section 19a, 19b, as well as a first other section 20a, 20b, the first section 18a, 18b being disposed on the first arm member 15 and the second section 19a, 19b being disposed on the second arm member 16, the first section 18a and the second section 19a or the first section 18b and the second section 19b being connected to each other in an electrically conductive manner in a joint area 21 of the articulated arm device 13 by means of the first other section 20a or 20b. The second sections 19a, 19b are disposed on two arms 22 running parallel to each other in sections of the second arm member 16 or the double arm. Furthermore, each conductor 17a, 17b has a second other section not shown here and a third other section also not shown here, the second other section connecting the second section 19a, 19b to one of the charging contacts 11 in an electrically conductive manner, the third other section being connected to the first section 18a, 18b in an electrically conductive manner at one end and being connectable, in particular to the charging contact, at the other end. Further, the first sections 18a, 18b and the second sections 19a, 19b are each formed as a profile formed of aluminum, which has a cross-sectional area of 400 mm² and is insulated from the outside with a powder coating. The three other sections 20a, 20b are round strands formed of copper.

Further, the contact device 12 has two charging contact carriers 23 with the charging contacts 11 disposed thereon. The charging contacts 11 are connected to each other via a rod assembly 24 of the contact device 12 in each case with a connecting rod 25 for connecting two charging contacts 11 and with a carrier rod 26 disposed transversely to the connecting rods 25 for connecting the charging contact carriers 23.

Further, the positioning unit 10 has a support frame 27 for fastening the positioning unit 10, in particular above the vehicle.

1. A positioning unit (10) for producing an electrically conductive connection between a stationary charging station and an electrically powered vehicle, an electric charging contact (11) of a contact device (12) of the positioning unit being movable in relation to a charging contact surface and being contactable therewith by means of the positioning unit, the positioning unit having an articulated arm device (13) and a power device (14) for powering the articulated arm device, the charging contact being positionable between a contact position for current transmission and a retracted position for current interruption by means of the articulated arm device, the positioning unit having at least one electric conductor (17a, 17b) provided for transmitting a charging current and essentially disposed on the articulated arm device, the electric conductor (17a, 17b) being connected to the charging contact at one end and being connectable to the charging station or to the vehicle at the other end, wherein
the conductor has at least one section (18a, 18b, 19a, 19b) formed predominantly, or completely, of aluminum.

2. The positioning unit according to claim 1, wherein the conductor (17a, 17b) is predominantly formed of aluminum with respect to a length of the conductor.

3. The positioning unit according to claims 1, wherein a cross-sectional area of the section (18a, 18b, 19a, 19b) is 300 mm² to 500 mm².

4. The positioning unit according to claim 1, wherein the section (18a, 18b, 19a, 19b) is designed as a profile part.

5. The positioning unit according to claim 1, wherein the conductor (17a, 17b) has an insulation in an area of the section (18a, 18b, 19a, 19b).

6. The positioning unit according to claim, wherein the conductor (17a, 17b) has at least one other section (20a, 20b) formed predominantly, or completely, of copper.

7. The positioning unit according to claim 6, wherein a cross-sectional area of the other section (20a, 20b) is 100 mm² to 150 mm².

8. The positioning unit according to claims 6, wherein the other section (20a, 20b) is formed as a strand.

9. The positioning unit according to claim 1, wherein a charging current of 800 A to 1500 A is transmittable by the conductor (17a, 17b).

10. The positioning unit according to claim 1, wherein the positioning unit (10) has a plurality of similar conductors (17a, 17b).

11. The positioning unit according to claim 1, wherein the articulated arm device (13) is designed as a one-arm system or as a crossbar system or as a pantograph.

12. The positioning unit according to claim 6, wherein the articulated arm device (13) has at least a first arm member (15) and a second arm member (16) connected to the first arm member in an articulated manner, the conductor (17a, 17b) having two sections (18a, 18b, 19a, 19b) formed predominantly or completely, of aluminum, a first section (18a, 18b) of the two sections being disposed on the first arm member and a second section (19a, 19b) of the two sections being disposed on the second arm member, the two sections being connected to each other in an electrically conductive manner in a joint area (21) of the articulated arm device by means of the other section (20a, 20b) of the conductor, which is formed predominantly or completely, of copper.

13. The positioning unit according to claim 12, wherein the conductor (17a, 17b) has three other sections (20a, 20b) formed predominantly, or completely, of copper, a first other section (17a, 17b) of the three other sections connecting the two sections (18a, 18b, 19a, 19b) to each other in the joint area in an electrically conductive manner, a second other section of the three other sections connecting the second section to the charging contact (11) in an electrically conductive manner and a third other section of the three other sections, which is connected to the first section in an electrically conductive manner, being connectable to the charging station or to the vehicle.

14. The positioning unit according to claim 12, wherein the first arm member (15) is formed as a single arm and the second arm member (16) is formed as a double arm, the contact device (12) being disposed on the end side of the second arm member.

15. The positioning unit according to claim 14, wherein the positioning unit (10) has two conductors (17a, 17b), a second section (19a, 19b) of the conductors, which is formed predominantly, or completely, of aluminum, being disposed on two arms (22) of the double arm extending parallel to each other at least in sections in each case.

16. The positioning unit according to claim 1, wherein the power device (14) has an actuator for producing an actuation force acting on the articulated arm device (13) and a spring mechanism interacting mechanically with the actuator.

17. The positioning unit according to claim 1, wherein the contact device (12) has two charging contact carriers (23), with at least two charging contacts (11) disposed thereon in each case.

18. The positioning unit according to claim 17, wherein the charging contacts (11) are connected to each other by a rod assembly (24) of the contact device (12) with at least one connecting rod (25) for connecting two charging contacts in each case and with at least one carrier rod (26) for connecting the charging contact carriers (23), the carrier rod (26) being disposed transversely to the connecting rods.

19. The positioning unit according to claim 1, wherein the positioning unit (10) has a support frame (27) for fastening the positioning unit above the vehicle.

20. A charging station comprising a mast, a boom or a bridge and a positioning unit (10) according to claim 1 disposed thereon above a vehicle.

21. A method for producing an electrically conductive connection between a stationary charging station and an electrically powered vehicle, an electric charging contact (11) of a contact device (12) of the positioning unit being moved in relation to a charging contact surface by means of a positioning unit (10) and being contacted therewith, an articulated arm device (13) of the positioning unit being powered by a power device (14) of the positioning unit, the charging contact being positioned between a contact position for current transmission and a retracted position for current interruption by means of the articulated arm device, a charging current being transmitted in the contact position by at least one electric conductor (17a, 17b) of the positioning unit, the electric conductor being essentially disposed on the articulated arm device and being connected to the charging contact at one end and to the charging station or to the vehicle at the other end, wherein the charging current is transmitted by at least one section (18a, 18b, 19a, 19b) of the conductor formed predominantly, or completely, of aluminum.
